(19) United States
(12) Patent Application Publication
(10) Pub. No.: US 2024/0388913 A1
(43) Pub. Date: Nov. 21, 2024

(54) VALIDITY OF PROTECTED END-TO-END INFORMATION IN USER EQUIPMENT (UE)-TO-UE RELAY COMMUNICATION

(71) Applicant: QUALCOMM Incorporated, San Diego, CA (US)

(72) Inventors: Hongil KIM, San Diego, CA (US); Soo Bum LEE, San Diego, CA (US)

(21) Appl. No.: 18/644,826

(22) Filed: Apr. 24, 2024

Related U.S. Application Data
(60) Provisional application No. 63/502,303, filed on May 15, 2023.

(51) Int. Cl. H04W 12/106; H04W 12/61; H04W 88/04

(52) U.S. Cl. CPC H04W 12/106; H04W 12/61; H04W 88/04

(57) ABSTRACT

Various aspects of the present disclosure generally relate to wireless communication. In some aspects, a relay user equipment (UE) may receive a message including protected end-to-end information associated with a target end UE. The relay UE may store validity information associated with the protected end-to-end information associated with the target end UE. The relay UE may perform a validity check for the protected end-to-end information based at least in part on the validity information. The relay UE may selectively transmit the protected end-to-end information associated with the target end UE based at least in part on a result of performing the validity check. Numerous other aspects are described.

### CROSS-REFERENCE TO RELATED APPLICATION

This Patent application claims priority to U.S. Provisional Patent Application No. 63/502,303, filed on May 15, 2023, entitled “VALIDITY OF PROTECTED END-TO-END INFORMATION IN USER EQUIPMENT (UE)-TO-UE RELAY COMMUNICATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for validity of protected end-to-end discovery information in user equipment (UE)-to-UE relay communication.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of a relay device that relays communications between a first UE and a second UE, in accordance with the present disclosure.

FIGS. 4A and 4B are diagrams of an example associated with validity of protected end-to-end discovery information in UE-to-UE (U2U) relay communication, in accordance with the present disclosure.

FIG. 5 is a diagram illustrating an example process performed, for example, by a relay UE, in accordance with the present disclosure.

FIG. 6 is a diagram illustrating an example process performed, for example, by a target end UE, in accordance with the present disclosure.

FIG. 7 is a diagram of an example apparatus for wireless communication, in accordance with the present disclosure.

### SUMMARY

Some aspects described herein relate to a method of wireless communication performed by a relay user equipment (UE). The method may include receiving a message including protected end-to-end information associated with a target end UE. The method may include storing validity information associated with the protected end-to-end information associated with the target end UE. The method may include performing a validity check for the protected end-to-end information based at least in part on the validity information. The method may include selectively transmitting the protected end-to-end information associated with the target end UE based at least in part on a result of performing the validity check.

Some aspects described herein relate to a method of wireless communication performed by a target end UE. The method may include transmitting a message including protected end-to-end information associated with the target end UE. The method may include storing validity information associated with the protected end-to-end information.

Some aspects described herein relate to a relay UE for wireless communication. The relay UE may include one or more memories and one or more processors coupled to the one or more memories. The one or more processors may be configured to receive a message including protected end-to-end information associated with a target end UE. The one or more processors may be configured to store validity information associated with the protected end-to-end information associated with the target end UE. The one or more processors may be configured to perform a validity check for the protected end-to-end information based at least in part on the validity information. The one or more processors may be configured to selectively transmit the protected end-to-end information associated with the target end UE based at least in part on a result of performing the validity check.

Some aspects described herein relate to a target end UE for wireless communication. The target end UE may include one or more memories and one or more processors coupled to the one or more memories. The one or more processors may be configured to transmit a message including protected end-to-end information associated with the target end UE. The one or more processors may be configured to store validity information associated with the protected end-to-end information.

Some aspects described herein relate to a non-transitory computer-readable medium that stores a set of instructions for wireless communication by a relay UE. The set of instructions, when executed by one or more processors of the relay UE, may cause the relay UE to receive a message including protected end-to-end information associated with a target end UE. The set of instructions, when executed by one or more processors of the relay UE, may cause the relay UE to store validity information associated with the protected end-to-end information associated with the target end UE. The set of instructions, when executed by one or more processors of the relay UE, may cause the relay UE to perform a validity check for the protected end-to-end information based at least in part on the validity information. The set of instructions, when executed by one or more processors of the relay UE, may cause the relay UE to selectively transmit the protected end-to-end information associated with the target end UE based at least in part on a result of performing the validity check.

Some aspects described herein relate to a non-transitory computer-readable medium that stores a set of instructions for wireless communication by a target end UE. The set of instructions, when executed by one or more processors of the target end UE, may cause the target end UE to transmit a message including protected end-to-end information associated with the target end UE. The set of instructions, when executed by one or more processors of the target end UE, may cause the target end UE to store validity information associated with the protected end-to-end information.

Some aspects described herein relate to an apparatus for wireless communication. The apparatus may include means for receiving a message including protected end-to-end information associated with a target end UE. The apparatus may include means for storing validity information associated with the protected end-to-end information associated with the target end UE. The apparatus may include means for performing a validity check for the protected end-to-end information based at least in part on the validity information. The apparatus may include means for selectively transmitting the protected end-to-end information associated with the target end UE based at least in part on a result of performing the validity check.

Some aspects described herein relate to an apparatus for wireless communication. The apparatus may include means for transmitting a message including protected end-to-end information associated with the apparatus. The apparatus may include means for storing validity information associated with the protected end-to-end information.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

In operation associated with relay discovery in support of user equipment (UE)-to-UE (U2U) relaying, an announcing relay UE may transmit a message including protected end-to-end discovery information associated with target end UEs previously discovered by the relay UE. A monitoring UE may check the protected end-to-end discovery information received in the message to determine whether the protected end-to-end discovery information includes an indication that a target end UE with which the monitoring UE is to communicate has been previously discovered by the relay UE. If so, the monitoring UE has successfully discovered the target end UE via the relay UE, after which route discovery and selection can be performed so as to enable communication between the monitoring UE (e.g., a source UE) and the target end UE (e.g., a destination UE) via the relay UE in association with a proximity-based service.

To support such operation, the relay UE should be capable of obtaining protected end-to-end discovery information from one or more target end UEs. End-to-end discovery information associated with a given target end UE may change or be modified over time, meaning that protected end-to-end discovery information received and stored by the relay UE may become invalid or expired at some point in time. Thus, the relay UE should be capable of determining whether protected end-to-end discovery information stored by the relay UE is valid in order to ensure that the relay UE does not transmit invalid or expired protected end-to-end discovery information associated with a given target end UE.

Some techniques and apparatuses described herein enable validity checking of protected end-to-end discovery information in U2U relay communication. In some aspects, a relay UE may receive, from a target end UE, a message including protected end-to-end information associated with the target end UE. The relay UE may store validity information associated with the protected end-to-end information. In some aspects, the relay UE may perform a validity check for the protected end-to-end information based at least in part on the validity information, and may selectively transmit the protected end-to-end information associated with the target end UE based at least in part on a result of performing the validity check. In this way, the relay UE may be capable of determining whether stored protected end-to-end discovery information associated with a given target end UE is valid, thereby ensuring that the relay UE transmits only valid protected end-to-end discovery information, which improves reliability and functionality of U2U relay communication.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

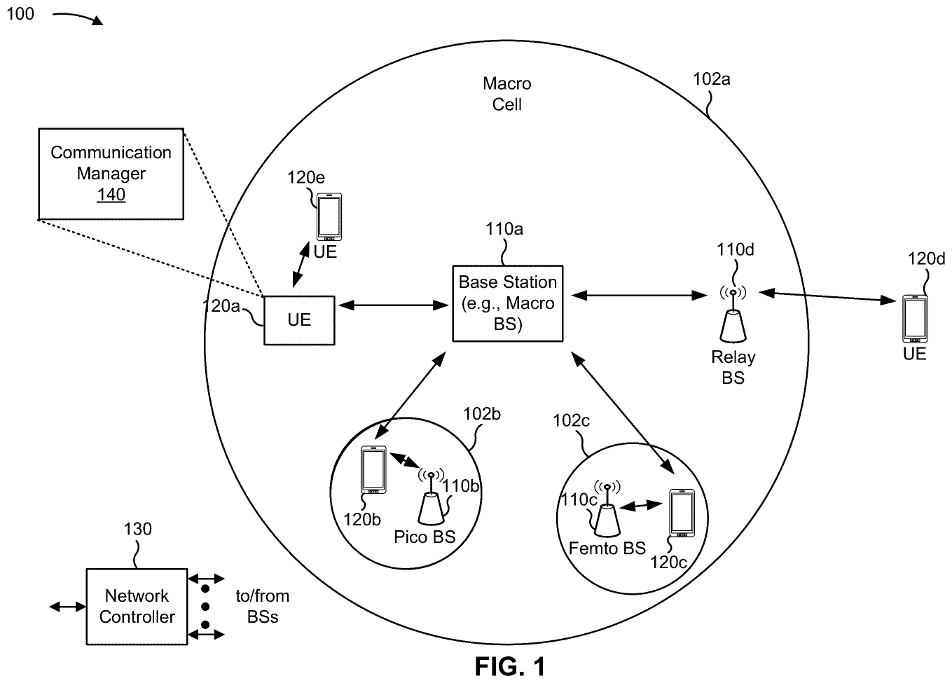

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a message including protected end-to-end information associated with a target end UE; store validity information associated with the protected end-to-end information associated with the target end UE; perform a validity check for the protected end-to-end information based at least in part on the validity information; and selectively transmit the protected end-to-end information associated with the target end UE based at least in part on a result of performing the validity check. Additionally, or alternatively, as described in more detail elsewhere herein, the communication manager 140 may transmit a message including protected end-to-end information associated with the UE 120; and store validity information associated with the protected end-to-end information. Additionally, or alternatively, the communication manager 140 may perform one or more other operations described herein.

As indicated above, FIG. 1 is provided as an example. Other examples may differ from what is described with regard to FIG. 1.

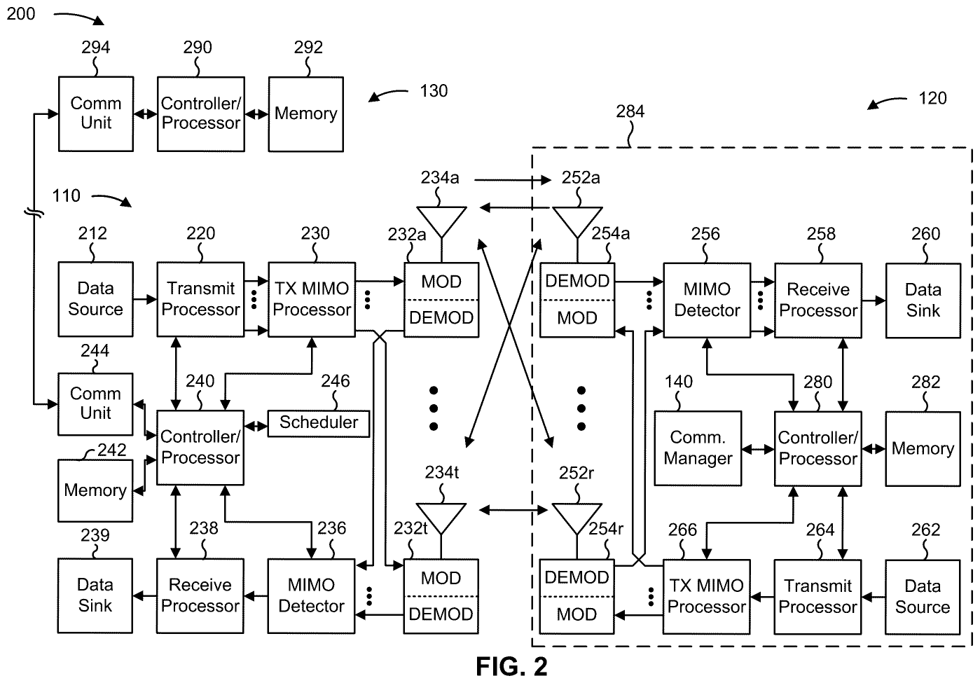

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

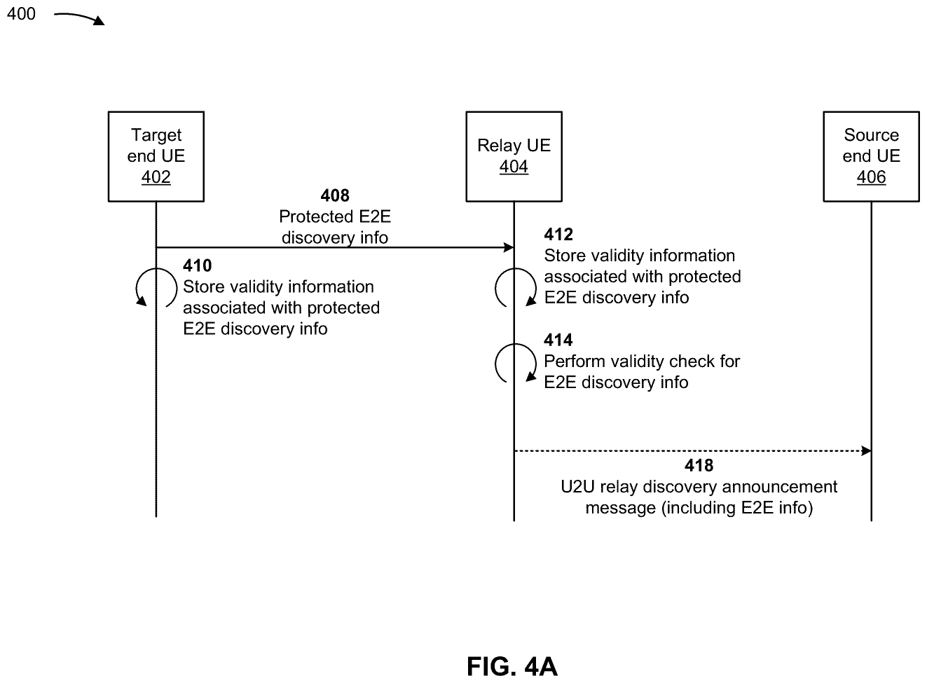

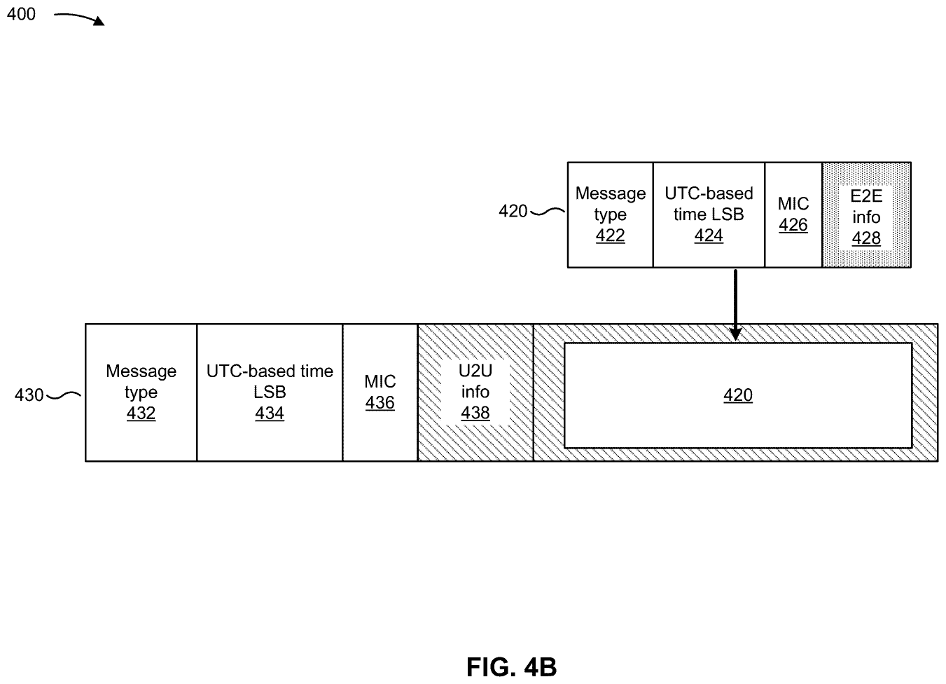

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4A-7).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4A-7).

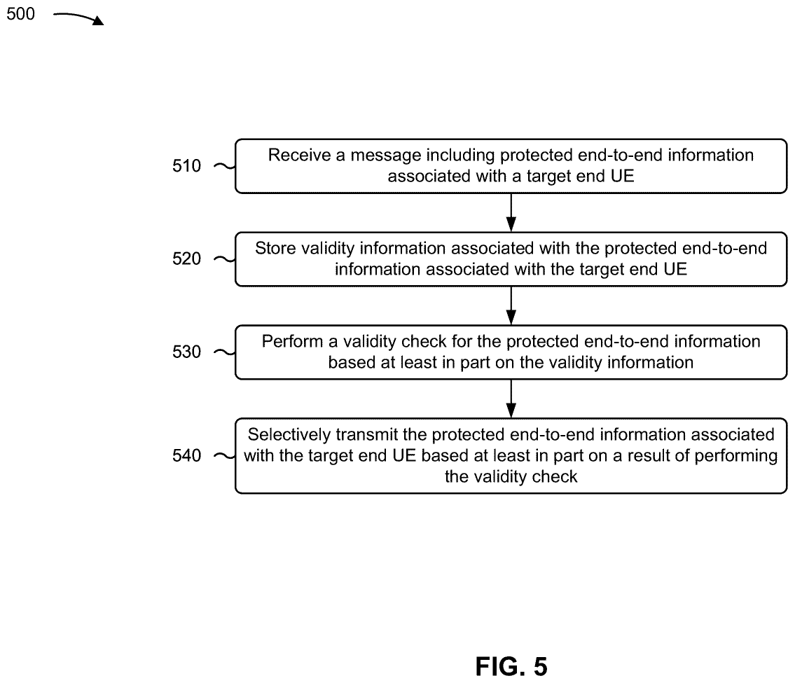

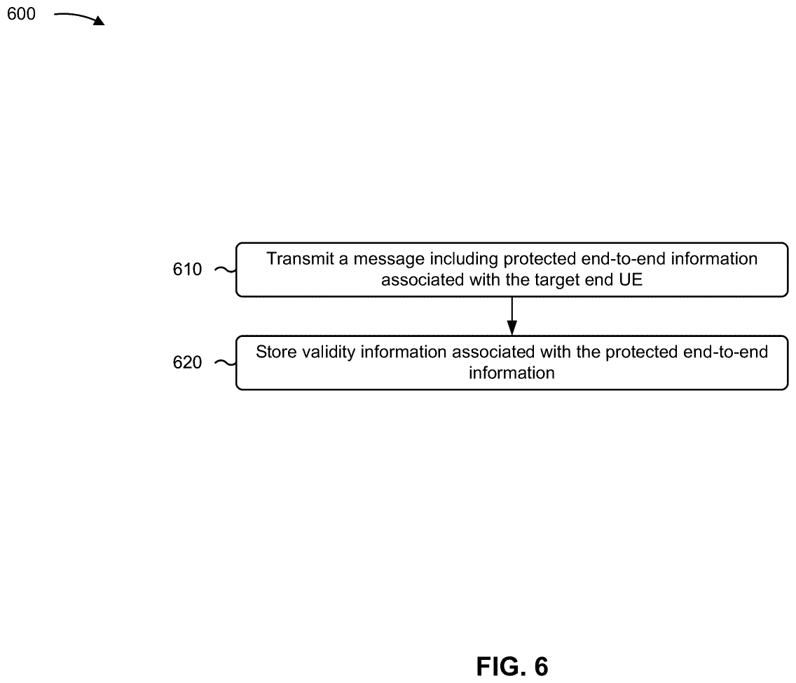

The controller/processor 240 of the network node 110, the controller/processor 280 of the UE 120, and/or any other component(s) of FIG. 2 may perform one or more techniques associated with validity of protected end-to-end discovery information in U2U relay communication, as described in more detail elsewhere herein. For example, the controller/processor 240 of the network node 110, the controller/processor 280 of the UE 120, and/or any other component(s) of FIG. 2 may perform or direct operations of, for example, process 500 of FIG. 5, process 600 of FIG. 6, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, a single processor may perform all of the operations described as being performed by the one or more processors. In some aspects, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

In some aspects, a relay UE (e.g., a UE 120) includes means for receiving a message including protected end-to-end information associated with a target end UE; means for storing validity information associated with the protected end-to-end information associated with the target end UE; means for performing a validity check for the protected end-to-end information based at least in part on the validity information; and/or means for selectively transmitting the protected end-to-end information associated with the target end UE based at least in part on a result of performing the validity check. The means for the relay UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a target end UE (e.g., a UE 120) includes means for transmitting a message including protected end-to-end information associated with the target end UE; and/or means for storing validity information associated with the protected end-to-end information. The means for the target end UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

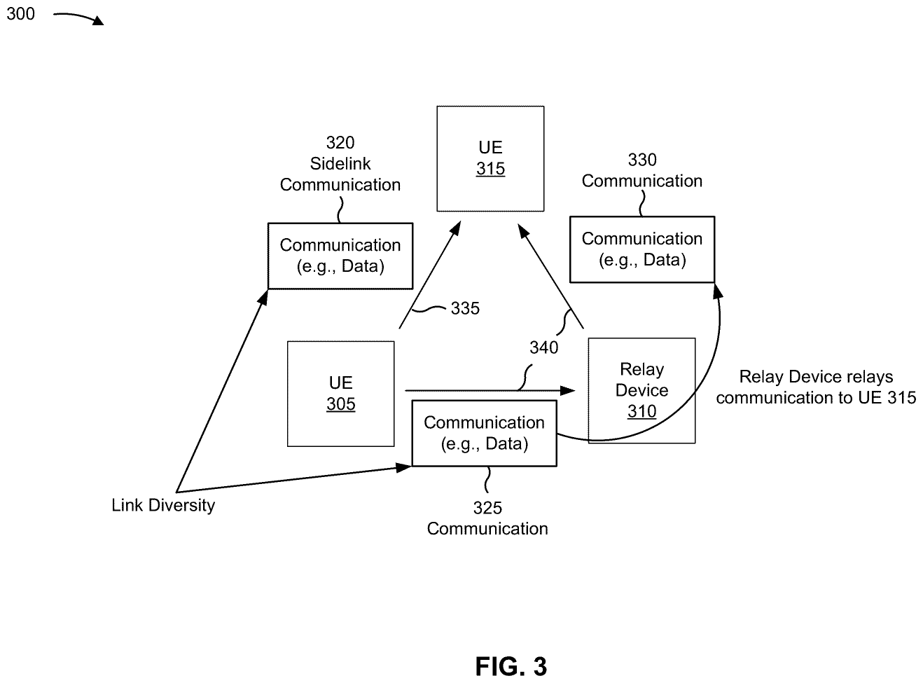

FIG. 3 is a diagram illustrating an example 300 of a relay device that relays communications between a first UE and a second UE, in accordance with the present disclosure. As shown, example 300 includes a UE 305, a relay device 310, and a UE 315. In example 300, the UE 305 is a transmit (Tx) UE (sometimes referred to as a source end UE), the relay device 310 is a relay UE (i.e., a U2U relay UE), and the UE 315 is a receive (Rx) UE (sometimes referred to as a target end UE). In some aspects, the UE 305 is a first UE 120, the relay device 310 is a second UE 120, and the UE 315 is a third UE 120.

As shown in FIG. 3, the UE 305 may transmit a communication (for example, data or control information) directly to the UE 315 as a sidelink communication 320. Additionally or alternatively, the UE 305 may transmit a communication (for example, data or control information) indirectly to the UE 315 via the relay device 310. For example, the UE 305 may transmit the communication to the relay device 310 as a communication 325, and the relay device 310 may relay (for example, forward or transmit) the communication to the UE 315 as a communication 330.

In some aspects, the UE 305 may communicate directly with the UE 315 via a sidelink 335. For example, the sidelink communication 320 may be transmitted via the sidelink 335. A communication transmitted via the sidelink 335 between the UE 305 and the UE 315 (for example, in the sidelink communication 320) does not pass through and is not relayed by the relay device 310. In some aspects, the UE 305 may communicate indirectly with the UE 315 via an indirect link 340. For example, the communication 325 and the communication 330 may be transmitted via different segments of the indirect link 340. A communication transmitted via the indirect link 340 between the UE 305 and the UE 315 (for example, in the communication 325 and the communication 330) passes through and is relayed by the relay device 310.

Using the communication scheme shown in FIG. 3 may improve network performance and increase reliability by providing the UE 305 with link diversity for communicating with the UE 315. For millimeter wave (for example, frequency range 2, or FR2) communications, which are susceptible to link blockage and link impairment, this link diversity improves reliability and prevents multiple retransmissions of data that may otherwise be retransmitted in order to achieve a successful communication. Similarly, for V2X communications, which may be associated with a limited spectrum for communications, this link diversity improves reliability and prevents multiple retransmissions of data that may otherwise be retransmitted in order to achieve a successful communication. However, techniques described herein are not limited to millimeter wave communications, and may be used for sub-6 gigahertz (for example, frequency range 1, or FR1) communications.

In some cases, the UE 305 may transmit a communication (for example, the same communication) to the UE 315 via both the sidelink 335 and the indirect link 340. In other cases, the UE 305 may select one of the links (for example, either the sidelink 335 or the indirect link 340), and may transmit a communication to the UE 315 using only the selected link. Alternatively, the UE 305 may receive an indication of one of the links (for example, either the sidelink 335 or the indirect link 340), and may transmit a communication to the UE 315 using only the indicated link. The indication may be transmitted by the UE 315 or the relay device 310. In some aspects, such selection or indication may be based at least in part on channel conditions or link reliability.

In some aspects, the techniques and apparatuses for validity of protected end-to-end discovery information in U2U relay communication described herein may be applied to the relaying of communications between UEs as described in connection with FIG. 3.

As indicated above, FIG. 3 is provided as an example. Other examples may differ from what is described with respect to FIG. 3.

A wireless communication system may be capable of supporting proximity services (ProSe) that enable direct communication between UEs, such as sidelink communication over a PC5 interface. Notably, ProSe can provide both discovery capabilities and communication capabilities in association with enabling direct communication between UEs.

Additionally, the wireless communication system may be capable of supporting UE-to-UE relaying. UE-to-UE relaying can be utilized to enable coverage extension of communications between UEs. That is, UE-to-UE relaying can be utilized to support or enhance communications between UEs that are enabled by ProSe. A relay UE is a UE that relays traffic between a source end UE and a target end UE. The source end UE is the UE that is the originator of the relayed traffic, while the target end UE is the UE that is the destination of the relayed traffic. UE-to-UE relaying can support single-hop relaying (for example, a single relay UE between the source end UE and the target end UE) or multi-hop relaying (for example, more than one relay UEs in communication with one other to support relaying between the source end UE and the target end UE).

To utilize or participate in UE-to-UE relaying, a given UE communicates with a network entity (for example, a base station) to perform UE-to-UE relaying authorization and provisioning. After authorization and provisioning by the network entity, the UE performs a relay discovery procedure associated with discovering relay UEs in range of the UE. A first approach for enabling a UE to perform discovery of relay UEs is a proactive approach. According to the proactive approach, an announcing relay UE transmits a message to indicate its presence to other UEs. Here, monitoring UEs that are monitoring for such messages may receive the message transmitted by the announcing relay UE and, therefore, may discover the announcing relay UE. A second approach for enabling a UE to perform discovery of relay UEs is an on-demand approach. According to the on-demand approach, a discoverer UE transmits a message requesting that any discoveree relay UEs that receive the message transmit a response indicating their presence. Here, a discoveree relay UE monitoring for such messages receives the message transmitted by the discoverer UE and transmits a response indicating its presence. The discoverer UE may receive the response transmitted by the discoveree relay UE and, therefore, may discover the discoveree relay UE. A message transmitted by a given relay UE in association with performing relay discovery can include a relay service code (RSC) that identifies the relay UE and a UE-to-UE relay layer indicator that indicates whether the relay UE supports Layer 3 (L3) or Layer 2 (L2) UE-to-UE relay operation.

After relay discovery, a UE can perform a route discovery procedure to discover a UE-to-UE relaying route to be utilized for reaching a particular UE. For example, to perform relay discovery, the UE may need to discover one or more relay UEs that provide a route between the UE and a particular UE (for example, when the particular UE has not been discovered by the UE, such as when the particular UE is out-of-coverage). The particular UE may be, for example, a UE supporting a ProSe service, a UE that is a member of a specific group of UEs, or a UE that corresponds to application user information associated with the UE, among other examples. Notably, as described below, an RSC-based discovery procedure can be used to support forwarding of ProSe discovery messages via one or more relay UEs. Further, information used by a UE for ProSe discovery can be included in end-to-end UE discovery information within a message associated with performing route discovery.

Route discovery can be performed using a proactive approach or an on-demand approach. According to the proactive approach, an announcing UE may broadcast an announcement message intended for a monitoring UE. The announcement message may include, for example, user information associated with the announcing UE, an RSC associated with the announcing UE, and end-to-end discovery information associated with the monitoring UE (for example, information that identifies or can be used to identify the monitoring UE). In one example, an relay UE receives the announcement message, adds information associated with the relay UE (for example, user information associated with the relay UE, an RSC associated with the relay UE, or a UE-to-UE layer indication associated with the relay UE, among other examples) to the announcement message, and re-broadcasts the announcement message including the additional information. Here, the monitoring UE receives the re-broadcasted announcement message and determines that the announcement message originated from the announcing UE and is intended for the monitoring UE. The monitoring UE may then discover the route to the announcing UE via the relay UE. Notably, the monitoring UE may discover one or more routes to the announcing UE in this manner. Further, the announcement message may be received, modified, and transmitted by multiple relay UEs. That is, a given discovered route between the announcing UE and the monitoring UE may include hops through multiple relay UEs.

According to the on-demand approach, a discoverer UE may broadcast a solicitation message intended for a discoveree UE. The solicitation message may include, for example, user information associated with the discoverer UE, an RSC associated with the discoverer UE, and end-to-end discovery information associated with the discoveree UE (for example, information that identifies or can be used to identify the discoveree UE). In one example, an relay UE receives the solicitation message, adds information associated with the relay UE (for example, user information associated with the relay UE, an RSC associated with the relay UE, or a UE-to-UE layer indication associated with the relay UE, among other examples) to the solicitation message, and re-broadcasts the solicitation message including the additional information. Here, the discoveree UE receives the re-broadcasted solicitation message and determines that the solicitation message originated from the discoverer UE and is intended for the discoveree UE. The discoveree UE may then discover the route to the discoverer UE via the relay UE. Further, according to the on-demand approach, the discoveree UE may broadcast a solicitation response message intended for the discoverer UE. The solicitation response message may include, for example, user information associated with the discoveree UE, an RSC associated with the discoveree UE, and end-to-end discovery information associated with the discoverer UE (for example, information that identifies or can be used to identify the discoverer UE). In this example, the relay UE receives the solicitation response message, adds information associated with the relay UE (for example, user information associated with the relay UE, an RSC associated with the relay UE, or a UE-to-UE layer indication associated with the relay UE, among other examples) to the solicitation response message, and re-broadcasts the solicitation response message including the additional information. Here, the discoverer UE receives the re-broadcasted solicitation response message and determines that the solicitation message originated from the discoveree UE and is intended for the discoverer UE. The discoverer UE may then discover the route to the discoveree UE via the relay UE. Notably, one or more routes between the discoverer UE and the discoveree UE can be discovered in this manner. Further, the solicitation message or the solicitation response message may be received, modified, and transmitted by multiple relay UEs. That is, a given discovered route between the discoverer UE and the discoveree UE may include hops through multiple relay UEs.

After route discovery, a UE can perform a route selection procedure to select a route to be utilized for UE-to-UE relaying. The route selection procedure can be used by a UE (for example, an source end UE or a target end UE) to select a route from a set of discovered routes. Route selection can be performed based on some criteria configured on the UE. For example, the UE may be configured with radio link quality criteria that indicate a threshold for a reference signal (for example, a sidelink discovery reference signal received power (SD-RSRP) threshold, or a sidelink reference signal received power (SL-RSRP) threshold). Here, the UE may select a route for which the radio link criteria are satisfied (for example, a route for which the SD-RSRP threshold is satisfied, or a route for which the SL-RSRP threshold is satisfied). When the UE is in coverage, the UE can be configured with the criteria for performing route selection via a system information block (SIB). Conversely, when the UE is out-of-coverage the UE may utilize criteria that are pre-configured on the UE.

After route selection, UE-to-UE relay connection setup is performed, and communication between an source end UE and a target end UE can be performed over the selected route utilizing UE-to-UE relaying. Notably, after relay connection setup is performed, mobility management can be utilized to, for example, re-select the route or perform relay connection management (for example, additional relay connection setup, modification of the relay connection, or release of the relay connection, among other examples).

As noted above, a first approach for enabling a UE to perform discovery of relay UEs is a proactive approach according to which an announcing relay UE transmits a message to indicate its presence to other UEs, and monitoring UEs receive the message transmitted by the announcing relay UE, thereby enabling discovery of the announcing relay UE. According to this proactive approach, the announcing relay UE first obtains end-to-end discovery information associated with one or more target end UEs. A target end UE may be, for example, a UE provisioned with a ProSe service that provides communication (e.g., direct communication or communication through one or more relay UEs) with another UE provisioned with the ProSe service. That is, the target end UE may be an “end point” of a communication link supporting the ProSe service that enables communication between two target end UEs. In the context of UE-to-UE relaying, a target end UE may be a target end UE.

In operation, the relay UE may obtain end-to-end discovery information for target end UEs previously discovered by the relay UE so that the relay UE can transmit (e.g., broadcast) the end-to-end discovery information associated with the previously discovered target end UEs in the message intended for monitoring UEs. End-to-end discovery information associated with a UE may include, for example, user information associated with the UE (e.g., a user information identifier) or a ProSe code associated with a ProSe service that the UE is to discover or use. The ProSe code may include, for example, a ProSe application code that is associated with a ProSe application identity (ID) that can be used in an open ProSe direct discovery procedure, with the ProSe application ID being an identity (e.g., a globally unique identity) used for open ProSe direct discovery and identifying application related information for the UE. The relay UE may be configured to transmit one or more items of end-to-end discovery information (e.g., a list of end-to-end discovery information), where each item is associated with a respective UE. End-to-end discovery information associated with one or more previously discovered UEs may also be referred to as a direct discovery set. In some scenarios, hop-by-hop and end-to-end security may be provided, meaning that end-to-end discovery information obtained by the relay UE may be protected (e.g., encrypted based at least in part on a set of security parameters associated with end-to-end ProSe direct discovery).

In operation, a monitoring UE may receive the message including protected end-to-end discovery information associated with the target end UEs previously discovered by the relay UE. In one example, the monitoring UE may be an source end UE. Here, the monitoring UE checks the protected end-to-end discovery information received in the message broadcasted by the relay UE to determine whether the protected end-to-end discovery information includes an indication that a target end UE, to which the source end UE is to transmit a communication, has been previously discovered by the relay UE. If so, the source end UE has successfully discovered the target end UE via the relay UE, after which route discovery and selection can be performed so as to enable communication between the source end UE and the target end UE (via the relay UE) in association with a ProSe service.

As noted above, the relay UE obtains protected end-to-end discovery information from a given target end UE. End-to-end discovery information associated with a given target end UE may change or be modified over time, meaning that protected end-to-end discovery information received and stored by the relay UE may become invalid or expired at some point in time. Thus, the relay UE should be capable of determining whether protected end-to-end discovery information stored by the relay UE is valid in order to ensure that the relay UE does not transmit invalid or expired protected end-to-end discovery information associated with a given target end UE.

Some techniques and apparatuses described herein enable validity checking of protected end-to-end discovery information in U2U relay communication. In some aspects, a relay UE may receive, from a target end UE, a message including protected end-to-end information associated with the target end UE. The relay UE may store validity information associated with the protected end-to-end information. In some aspects, the relay UE may perform a validity check for the protected end-to-end information based at least in part on the validity information, and may selectively transmit the protected end-to-end information associated with the target end UE based at least in part on a result of performing the validity check. In this way, the relay UE may be capable of determining whether stored protected end-to-end discovery information associated with a given target end UE is valid, thereby ensuring that the relay UE transmits only valid protected end-to-end discovery information, which improves reliability and functionality of U2U relay communication.

FIGS. 4A and 4B are diagrams of an example 400 associated with validity of protected end-to-end discovery information in U2U relay communication, in accordance with the present disclosure. As shown in FIG. 4A, example 400 includes communication among a target end UE 402 (e.g., a first UE 120), a relay UE 404 (e.g., a second UE 120), and a source end UE 406 (e.g., a third UE 120).

As shown at reference 408 in FIG. 4A, the target end UE 402 may transmit, and the relay UE 404 may receive, a message including protected end-to-end information associated with the target end UE 402. The protected end-to-end discovery information may include, for example, encrypted end-to-end discovery information (e.g., end-to-end discovery information that has been encrypted based at least in part on a set of security parameters associated with end-to-end ProSe direct discovery). In some aspects, the target end UE 402 transmits the end-to-end discovery information based at least in part on communicating with the relay UE 404. For example, the target end UE 402 may determine (e.g., based at least in part on a ProSe service configuration, a U2U configuration, or the like) that the target end UE 402 is to be discovered by one or more source end UEs 406 for the purpose of participating in U2U relay communication. Here, upon communicating with the relay UE 404, the target end UE 402 may transmit the message including the protected end-to-end discovery information associated with the target end UE 402.

In some aspects, the target end UE 402 may transmit, and the relay UE 404 may receive, the message via a direct communication interface between the target end UE 402 and the relay UE 404. For example, the target end UE 402 may transmit, and the relay UE 404 may receive, a PC5-S message including the protected end-to-end discovery information associated with target end UE 402. Notably, in such an aspect, the target end UE 402 automatically provides the protected end-to-end discovery information (e.g., without receiving an explicit indication or trigger) to the relay UE 404.

In some aspects, the target end UE 402 transmits the protected end-to-end information based at least in part on a determination that protected end-to-end information associated with the target end UE 402 has not previously been transmitted.

Additionally, or alternatively, the target end UE 402 may transmit the protected end-to-end information based at least in part on a determination that previously transmitted protected end-to-end information associated with the target end UE 402 has expired. For example, the target end UE 402 may determine that protected end-to-end discovery information previously transmitted by the target end UE 402 has expired, and may transmit the protected end-to-end discovery information based at least in part on this determination. In some aspects, the target end UE 402 may determine that the protected end-to-end information has expired based at least in part on stored validity information associated with previously transmitted protected end-to-end information (e.g., in a manner similar to that described below with respect to reference 414).

In some aspects, the target end UE 402 broadcasts the protected end-to-end discovery information associated with the target end UE 402. For example, the target end UE 402 may broadcast a message including the protected end-to-end discovery information in association with enabling route discovery for U2U relaying. Here, the relay UE 404 may receive the message including the protected end-to-end discovery information broadcasted by the target end UE 402.

In some aspects, the relay UE 404 relay broadcasts a request (e.g., an announcement message with empty end-to-end discovery information list). Here, the target end UE 402 May receive the broadcasted request and may reply with the message including the protected end-to-end discovery information.

In some aspects, the protected end-to-end discovery information associated with the target end UE 402 includes user information associated with the target end UE. Additionally, or alternatively, the protected end-to-end discovery information may include a ProSe code associated with a ProSe service to be discovered or used by the target end UE 402.

FIG. 4B illustrates an example associated with a message including the protected end-to-end discovery information that may be transmitted by the target end UE 402 and received by the relay UE 404. In this example, both hop-by-hop protection and end-to-end protection are provided. For example, as indicated in the upper diagram of FIG. 4B, the target end UE 402 may encrypt the end-to-end discovery information based at least in part on a set of security parameters (e.g., a set of code sending security parameters associated with a ProSe service) to generate the protected end-to-end discovery information associated with the target end UE 402. The protected end-to-end discovery information may be carried in an end-to-end (E2E) field 428 of a frame 420. The frame 420 may further include a set of bits indicating a message type (e.g., in a message type field 422), a set of coordinated universal time (UTC)-based time counter least significant bit (LSB) bits (e.g., in a UTC-based time counter LSB field 424), and a set of message integrity check (MIC) bits (e.g., in a MIC field 426). As indicated in the lower diagram of FIG. 4B, the target end UE 402 may encrypt the UE-to-UE information and the frame 420 based at least in part on another set of security parameters (e.g., a set of code sending security parameters associated with a U2U service). The protected U2U information may be carried in an U2U field 438 of a frame 430, along with the encrypted frame 420. The frame 430 may further include a set of bits indicating a message type (e.g., in a message type field 432), a set of UTC-based time counter LSB bits (e.g., in a UTC-based time counter LSB field 434), and a set of MIC bits (e.g., in a MIC field 436).

Returning to FIG. 4A, as shown at reference 410, the target end UE 402 may store validity information associated with the protected end-to-end discovery information. Similarly, as shown at reference 412, the relay UE 404 (e.g., upon receiving the protected end-to-end discovery information associated with the target end UE 402) may store validity information associated with the protected end-to-end discovery information.

Validity information includes information that can be used to determine whether protected end-to-end discovery information is valid (e.g., whether the protected end-to-end discovery information has expired) at a given point in time. In some aspects, the validity information includes information indicating a time window. The time window is a period of time during which the protected end-to-end discovery information is valid (e.g., has yet to expire). In some aspects, the validity information includes information indicating a time at which the target end UE 402 transmits the message including the protected end-to-end information, which may be utilized as a start time for validity of the protected end-to-end discovery information. In some aspects, validity of the protected end-to-end discovery information at a given point in time can be checked (e.g., by the target end UE 402 or the relay UE 404) based at least in part on the information indicating the time window and the validity start time, as described below.

In some aspects, the time window may be configured via a network configuration (e.g., received by the target end UE 402 or the relay UE 404) that includes the information indicating the time window. In some such aspects, the target end UE 402 may determine a length of a UTC-based time counter LSB field 424 of the message in which the protected end-to-end discovery information is carried based at least in part on the information indicating the time window. For example, the target end UE 402 may receive (e.g., from a network device during discovery security parameters provisioning or U2U relay service policy and parameters provisioning) a configuration including the information indicating the time window. Here, the target end UE 402 may determine the length of the UTC-based time counter LSB field in the message to be transmitted by the target end UE 402 based at least in part on the network-configured time window. For example, if the configuration indicates that the time window is 256 seconds, then the target end UE 402 may determine the length of the UTC-based time counter LSB field as 4 bits (e.g., 2⁴=16). Here, the target end UE 402 may include the 4 LSBs from a UTC-based time counter (maintained by the target end UE 402) at the time at which the message is transmitted by the target end UE 402. In this example, upon receiving the message, the relay UE 404, may determine the length of time window based at least in part on the length of the UTC-based time counter LSB field. For example, the relay UE 404 may determine that the UTC-based time counter field is 4 bits in length, and may then determine that the time window is 16 seconds (e.g., 2⁴+=16) in length. Alternatively, the information indicating the time window may in some aspects be determined based at least in part on a predefined length of the UTC-based time counter LSB field (e.g., when the time window is not configured via a network configuration).

In some aspects, the information indicating the time at which the target end UE 402 transmitted the protected end-to-end information (i.e., the validity start time) is determined based at least in part on a UTC-based time counter. The validity start time can in some aspects be expressed in unit of seconds and coded in binary format as a set of least significant bits (e.g., the 32 LSBs) of a coordinated universal time as maintained by the target end UE 402 and the relay UE 404. In one example, the target end UE 402 may transmit 4 LSBs of a UTC-based time counter in the UTC-based time counter LSB field. That is, the target end UE 402 may include the 4 LSBs from a UTC-based time counter (maintained by the target end UE 402) at the time at which the message is transmitted. In this example, upon receiving the message, the relay UE 404, may determine the validity start time by replacing the last 4 LSBs of a UTC-based time counter maintained by the relay UE 404 with the 4 LSBs carried in the UTC-based time counter LSB field of the message. Notably, while the above examples use 4 LSBs and 16 seconds as an example, other values can be used in practice.

In some aspects, the relay UE 404 may verify an integrity of the message prior to storing the validity information. For example, the relay UE 404 may process the message by, for example, decrypting the message and verifying the integrity of the message using a set of bits carried in MIC field 436 of the message.

As shown at reference 414, the relay UE 404 may perform a validity check for the protected end-to-end information based at least in part on the validity information. For example, the relay UE 404 may perform a validity check for the protected end-to-end discovery information in preparation of possible transmission of the protected end-to-end discovery information (e.g., in an end-to-end information list carried in an announcement message).

In some aspects, to perform the validity check, the relay UE 404 may determine, based at least in part on a current time and the validity information, whether the protected end-to-end information associated with the target end UE has expired. For example, the relay UE 404 may determine a current time according to a UTC-based time counter maintained by the relay UE 404. The relay UE 404 may then determine whether the current time is within the time window (e.g., 16 seconds) starting from the validity start time. Here, if the current time is within the time window, then the relay UE 404 may determine that the protected end-to-end discovery information is valid (e.g., is not expired). Conversely, if the current time is not within the time window, then the relay UE 404 may determine that the protected end-to-end discovery information is invalid (e.g., has expired). In some aspects, the target end UE 402 may perform a validity check of its own protected end-to-end discovery information in a similar manner (e.g., to determine whether the target end UE 402 should transmit updated protected end-to-end discovery information). In some aspects, if the relay UE 404 determines that the protected end-to-end discovery information has expired, the relay UE 404 may transmit, for reception by the target end UE 402, a request for updated protected end-to-end information associated with the target end UE 402.

As shown at reference 418, the relay UE 404 may selectively transmit the protected end-to-end information associated with the target end UE 402 based at least in part on a result of performing the validity check. For example, the relay UE 404 may transmit the protected end-to-end information based at least in part on the result of the validity check indicating that the protected end-to-end information has not expired. Conversely, the relay UE 404 may refrain from transmitting the protected end-to-end information based at least in part on the result of the validity check indicating that the protected end-to-end information has expired.

In some aspects, in association with transmitting the protected end-to-end discovery information, the relay UE 404 may generate an end-to-end information list that includes one or more items of valid protected end-to-end discovery information (e.g., a direct discovery set), where each item may be associated with a respective target end UE 402. The relay UE 404 may then transmit (e.g., broadcast) the end-to-end information list including the end-to-end discovery information associated with the one or more target end UEs 402. In some aspects, the source end UE 406 may receive the message including valid protected end-to-end discovery information associated with the target end UEs 402 previously discovered by the relay UE 404.

In this way, the relay UE 404 may be determine whether stored protected end-to-end discovery information associated with a given target end UE 402 is valid, thereby ensuring that the relay UE 404 transmits only valid protected end-to-end discovery information, which improves reliability and functionality of U2U relay communication.

As indicated above, FIGS. 4A and 4B are provided as examples. Other examples may differ from what is described with respect to FIGS. 4A and 4B.

FIG. 5 is a diagram illustrating an example process 500 performed, for example, by a relay UE, in accordance with the present disclosure. Example process 500 is an example where the relay UE (e.g., UE 120) performs operations associated with validity of protected end-to-end information in U2U relay communication.

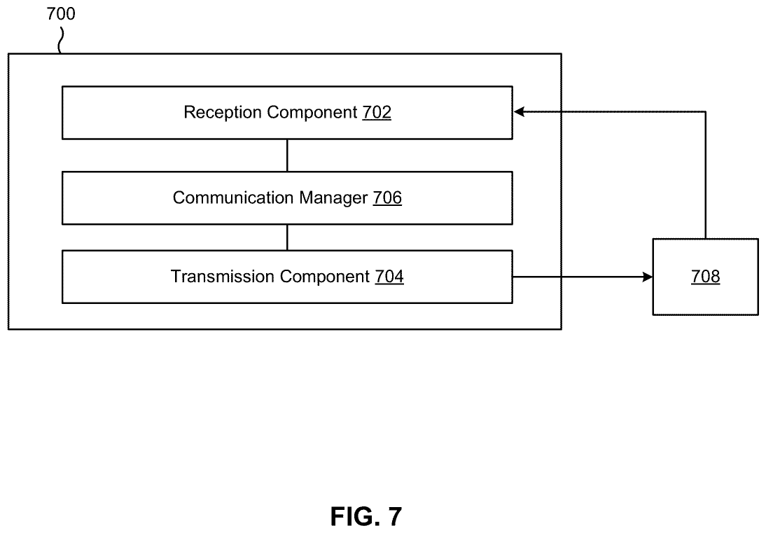

As shown in FIG. 5, in some aspects, process 500 may include receiving a message including protected end-to-end information associated with a target end UE (block 510). For example, the relay UE (e.g., using reception component 702 and/or communication manager 706, depicted in FIG. 7) may receive a message including protected end-to-end information associated with a target end UE, as described above with respect to reference 408 of FIG. 4A and with respect to the example shown in FIG. 4B.

As further shown in FIG. 5, in some aspects, process 500 may include storing validity information associated with the protected end-to-end information associated with the target end UE (block 520). For example, the relay UE (e.g., using communication manager 706, depicted in FIG. 7) may store validity information associated with the protected end-to-end information associated with the target end UE, as described above with respect to reference 412 of FIG. 4A.

As further shown in FIG. 5, in some aspects, process 500 may include performing a validity check for the protected end-to-end information based at least in part on the validity information (block 530). For example, the relay UE (e.g., using communication manager 706, depicted in FIG. 7) may perform a validity check for the protected end-to-end information based at least in part on the validity information, as described above with respect to reference 414 of FIG. 4A.

As further shown in FIG. 5, in some aspects, process 500 may include selectively transmitting the protected end-to-end information associated with the target end UE based at least in part on a result of performing the validity check (block 540). For example, the relay UE (e.g., using transmission component 704 and/or communication manager 706, depicted in FIG. 7) may selectively transmit the protected end-to-end information associated with the target end UE based at least in part on a result of performing the validity check, as described above with respect to reference 418 of FIG. 4A.

Process 500 may include additional aspects, such as any single aspect or any combination of aspects described below and/or in connection with one or more other processes described elsewhere herein.

In a first aspect, process 500 includes verifying integrity of the message prior to storing the validity information.

In a second aspect, alone or in combination with the first aspect, the validity information comprises information indicating a time window.

In a third aspect, alone or in combination with one or more of the first and second aspects, process 500 includes receiving a network configuration including the information indicating the time window.

In a fourth aspect, alone or in combination with one or more of the first through third aspects, process 500 includes determining the information indicating the time window.

In a fifth aspect, alone or in combination with one or more of the first through fourth aspects, the information indicating the time window is determined based at least in part on a length of a UTC-based time counter LSB field included in the message.

In a sixth aspect, alone or in combination with one or more of the first through fifth aspects, the validity information comprises information indicating a time at which the target end UE transmitted the protected end-to-end information.

In a seventh aspect, alone or in combination with one or more of the first through sixth aspects, process 500 includes determining the information indicating the time at which the target end UE transmitted the protected end-to-end information based at least in part on a set of bits included in a UTC-based time counter LSB field of the message.

In an eighth aspect, alone or in combination with one or more of the first through seventh aspects, performing the validity check comprises determining, based at least in part on a current time and the validity information, whether the protected end-to-end information associated with the target end UE has expired.

In a ninth aspect, alone or in combination with one or more of the first through eighth aspects, selectively transmitting the protected end-to-end information comprises transmitting the protected end-to-end information based at least in part on the result of the validity check indicating that the protected end-to-end information has not expired.

In a tenth aspect, alone or in combination with one or more of the first through ninth aspects, selectively transmitting the protected end-to-end information comprises refraining from transmitting the protected end-to-end information based at least in part on the result of the validity check indicating that the protected end-to-end information has expired.

In an eleventh aspect, alone or in combination with one or more of the first through tenth aspects, process 500 includes transmitting a request for updated protected end-to-end information associated with the target end UE.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a target end UE, in accordance with the present disclosure. Example process 600 is an example where the target end UE (e.g., UE 120) performs operations associated with validity of protected end-to-end information in U2U relay communication.

As shown in FIG. 6, in some aspects, process 600 may include transmitting a message including protected end-to-end information associated with the target end UE (block 610). For example, the target end UE (e.g., using transmission component 704 and/or communication manager 706, depicted in FIG. 7) may transmit a message including protected end-to-end information associated with the target end UE, as described above with respect to reference 408 of FIG. 4A and with respect to FIG. 4B.

As further shown in FIG. 6, in some aspects, process 600 may include storing validity information associated with the protected end-to-end information (block 620). For example, the target end UE (e.g., using communication manager 706, depicted in FIG. 7) may store validity information associated with the protected end-to-end information, as described above with respect to reference 410 of FIG. 4A.

Process 600 may include additional aspects, such as any single aspect or any combination of aspects described below and/or in connection with one or more other processes described elsewhere herein.

In a first aspect, the validity information comprises information indicating a time window.

In a second aspect, alone or in combination with the first aspect, process 600 includes receiving a network configuration including the information indicating the time window.

In a third aspect, alone or in combination with one or more of the first and second aspects, process 600 includes determining a length of a UTC-based time counter LSB field of the message based at least in part on the information indicating the time window.

In a fourth aspect, alone or in combination with one or more of the first through third aspects, process 600 includes determining the information indicating the time window based at least in part on a predefined length of a UTC-based time counter LSB field.

In a fifth aspect, alone or in combination with one or more of the first through fourth aspects, the validity information comprises information indicating a time at which the target end UE transmits the protected end-to-end information.

In a sixth aspect, alone or in combination with one or more of the first through fifth aspects, the information indicating the time at which the target end UE transmitted the protected end-to-end information is based at least in part on a UTC-based time counter.

In a seventh aspect, alone or in combination with one or more of the first through sixth aspects, the protected end-to-end information is transmitted based at least in part on a determination that protected end-to-end information associated with the target end UE has not previously been transmitted.

In an eighth aspect, alone or in combination with one or more of the first through seventh aspects, the protected end-to-end information is transmitted based at least in part on a determination that previously transmitted protected end-to-end information associated with the target end UE has expired, the determination being based at least in part on stored validity information associated with the previously transmitted protected end-to-end information.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 140 described in connection with FIG. 1. As shown, the apparatus 700 may communicate with another apparatus 708, such as a UE or a network node (such as a CU, a DU, an RU, or a base station), using the reception component 702 and the transmission component 704.

In some aspects, the apparatus 700 may be configured to perform one or more operations described herein in connection with FIGS. 4A and 4B. Additionally, or alternatively, the apparatus 700 may be configured to perform one or more processes described herein, such as process 500 of FIG. 5, process 600 of FIG. 6, or a combination thereof. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 708. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

In some aspects, the reception component 702 may receive a message including protected end-to-end information associated with a target end UE. The communication manager 706 may store validity information associated with the protected end-to-end information associated with the target end UE. The communication manager 706 may perform a validity check for the protected end-to-end information based at least in part on the validity information. The transmission component 704 may selectively transmit the protected end-to-end information associated with the target end UE based at least in part on a result of performing the validity check.

In some such aspects, the communication manager 706 may verify integrity of the message prior to storing the validity information. In some aspects, the reception component 702 may receive a network configuration including the information indicating the time window. In some aspects, the communication manager 706 may determine the information indicating the time window. In some aspects, the communication manager 706 may determine the information indicating the time at which the target end UE transmitted the protected end-to-end information based at least in part on a set of bits included in a UTC-based time counter LSB field of the message. In some aspects, the transmission component 704 may transmit a request for updated protected end-to-end information associated with the target end UE.

Additionally, or alternatively, the transmission component 704 may transmit a message including protected end-to-end information associated with the UE. The communication manager 706 may store validity information associated with the protected end-to-end information.

In some such aspects, the reception component 702 may receive a network configuration including the information indicating the time window. In some aspects, the communication manager 706 may determine a length of a UTC-based time counter LSB field of the message based at least in part on the information indicating the time window. In some aspects, the communication manager 706 may determine the information indicating the time window based at least in part on a predefined length of a UTC-based time counter LSB field.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a relay UE, comprising: receiving a message including protected end-to-end information associated with a target end UE; storing validity information associated with the protected end-to-end information associated with the target end UE; performing a validity check for the protected end-to-end information based at least in part on the validity information; and selectively transmitting the protected end-to-end information associated with the target end UE based at least in part on a result of performing the validity check.

Aspect 2: The method of Aspect 1, further comprising verifying integrity of the message prior to storing the validity information.

Aspect 3: The method of any of Aspects 1-2, wherein the validity information comprises information indicating a time window.

Aspect 4: The method of Aspect 3, further comprising receiving a network configuration including the information indicating the time window.

Aspect 5: The method of Aspect 3, further comprising determining the information indicating the time window.

Aspect 6: The method of Aspect 5, wherein the information indicating the time window is determined based at least in part on a length of a UTC-based time counter LSB field included in the message.

Aspect 7: The method of any of Aspects 1-6, wherein the validity information comprises information indicating a time at which the target end UE transmitted the protected end-to-end information.

Aspect 8: The method of Aspect 7, further comprising determining the information indicating the time at which the target end UE transmitted the protected end-to-end information based at least in part on a set of bits included in a UTC-based time counter LSB field of the message.

Aspect 9: The method of any of Aspects 1-8, wherein performing the validity check comprises determining, based at least in part on a current time and the validity information, whether the protected end-to-end information associated with the target end UE has expired.

Aspect 10: The method of any of Aspects 1-9, wherein selectively transmitting the protected end-to-end information comprises transmitting the protected end-to-end information based at least in part on the result of the validity check indicating that the protected end-to-end information has not expired.

Aspect 11: The method of any of Aspects 1-10, wherein selectively transmitting the protected end-to-end information comprises refraining from transmitting the protected end-to-end information based at least in part on the result of the validity check indicating that the protected end-to-end information has expired.

Aspect 12: The method of Aspect 11, further comprising transmitting a request for updated protected end-to-end information associated with the target end UE.

Aspect 13: A method of wireless communication performed by a target end UE, comprising: transmitting a message including protected end-to-end information associated with the target end UE; and storing validity information associated with the protected end-to-end information.

Aspect 14: The method of Aspect 13, wherein the validity information comprises information indicating a time window.

Aspect 15: The method of Aspect 14, further comprising receiving a network configuration including the information indicating the time window.

Aspect 16: The method of Aspect 15, further comprising determining a length of a UTC-based time counter LSB field of the message based at least in part on the information indicating the time window.

Aspect 17: The method of Aspect 14, further comprising determining the information indicating the time window based at least in part on a predefined length of a UTC-based time counter LSB field.

Aspect 18: The method of any of Aspects 13-17, wherein the validity information comprises information indicating a time at which the target end UE transmits the protected end-to-end information.

Aspect 19: The method of Aspect 18, wherein the information indicating the time at which the target end UE transmitted the protected end-to-end information is based at least in part on a coordinated universal time (UTC)-based time counter.

Aspect 20: The method of any of Aspects 13-19, wherein the protected end-to-end information is transmitted based at least in part on a determination that protected end-to-end information associated with the target end UE has not previously been transmitted.

Aspect 21: The method of any of Aspects 13-20, wherein the protected end-to-end information is transmitted based at least in part on a determination that previously transmitted protected end-to-end information associated with the target end UE has expired, the determination being based at least in part on stored validity information associated with the previously transmitted protected end-to-end information.

Aspect 22: An apparatus for wireless communication at a device, comprising a processor; memory coupled with the processor; and instructions stored in the memory and executable by the processor to cause the apparatus to perform the method of one or more of Aspects 1-21.

Aspect 23: A device for wireless communication, comprising a memory and one or more processors coupled to the memory, the one or more processors configured to perform the method of one or more of Aspects 1-21.

Aspect 24: An apparatus for wireless communication, comprising at least one means for performing the method of one or more of Aspects 1-21.

Aspect 25: A non-transitory computer-readable medium storing code for wireless communication, the code comprising instructions executable by a processor to perform the method of one or more of Aspects 1-21.

Aspect 26: A non-transitory computer-readable medium storing a set of instructions for wireless communication, the set of instructions comprising one or more instructions that, when executed by one or more processors of a device, cause the device to perform the method of one or more of Aspects 1-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A relay user equipment (UE) for wireless communication, comprising:
a memory; and
one or more processors, coupled to the memory, configured to:
receive a message including protected end-to-end information associated with a target end UE;
store validity information associated with the protected end-to-end information associated with the target end UE;
perform a validity check for the protected end-to-end information based at least in part on the validity information; and
selectively transmit the protected end-to-end information associated with the target end UE based at least in part on a result of performing the validity check.

2. The relay UE of claim 1, wherein the one or more processors are further configured to verify integrity of the message prior to storing the validity information.

3. The relay UE of claim 1, wherein the validity information comprises information indicating a time window.

4. The relay UE of claim 3, wherein the one or more processors are further configured to receive a network configuration including the information indicating the time window.

5. The relay UE of claim 3, wherein the one or more processors are further configured to determine the information indicating the time window.

6. The relay UE of claim 5, wherein the information indicating the time window is determined based at least in part on a length of a coordinated universal time (UTC)-based time counter least significant bit (LSB) field included in the message.

7. The relay UE of claim 1, wherein the validity information comprises information indicating a time at which the target end UE transmitted the protected end-to-end information.

8. The relay UE of claim 7, wherein the one or more processors are further configured to determine the information indicating the time at which the target end UE transmitted the protected end-to-end information based at least in part on a set of bits included in a coordinated universal time (UTC)-based time counter least significant bit (LSB) field of the message.

9. The relay UE of claim 1, wherein the one or more processors, to perform the validity check, are configured to determine, based at least in part on a current time and the validity information, whether the protected end-to-end information associated with the target end UE has expired.

10. The relay UE of claim 1, wherein the one or more processors, to selectively transmit the protected end-to-end information, are configured to transmit the protected end-to-end information based at least in part on the result of the validity check indicating that the protected end-to-end information has not expired.

11. The relay UE of claim 1, wherein the one or more processors, to selectively transmit the protected end-to-end information, are configured to refrain from transmitting the protected end-to-end information based at least in part on the result of the validity check indicating that the protected end-to-end information has expired.

12. The relay UE of claim 11, wherein the one or more processors are further configured to transmit a request for updated protected end-to-end information associated with the target end UE.

13. A target end user equipment (UE) for wireless communication, comprising:
a memory; and
one or more processors, coupled to the memory, configured to:
transmit a message including protected end-to-end information associated with the target end UE; and
store validity information associated with the protected end-to-end information.

14. The target end UE of claim 13, wherein the validity information comprises information indicating a time window.

15. The target end UE of claim 14, wherein the one or more processors are further configured to receive a network configuration including the information indicating the time window.

16. The target end UE of claim 14, wherein the one or more processors are further configured to determine the information indicating the time window based at least in part on a predefined length of a coordinated universal time (UTC)-based time counter least significant bit (LSB) field.

17. The target end UE of claim 13, wherein the validity information comprises information indicating a time at which the target end UE transmits the protected end-to-end information.

18. The target end UE of claim 13, wherein the protected end-to-end information is transmitted based at least in part on a determination that protected end-to-end information associated with the target end UE has not previously been transmitted.

19. The target end UE of claim 13, wherein the protected end-to-end information is transmitted based at least in part on a determination that previously transmitted protected end-to-end information associated with the target end UE has expired, the determination being based at least in part on stored validity information associated with the previously transmitted protected end-to-end information.

20. A method of wireless communication performed by a relay user equipment (UE), comprising:
receiving a message including protected end-to-end information associated with a target end UE;
storing validity information associated with the protected end-to-end information associated with the target end UE;
performing a validity check for the protected end-to-end information based at least in part on the validity information; and
selectively transmitting the protected end-to-end information associated with the target end UE based at least in part on a result of performing the validity check.
